(19) United States
(12) Patent Application Publication
(10) Pub. No.: US 2007/0276677 A1
(43) Pub. Date: Nov. 29, 2007

(54) Method and apparatus for dispensing tanning lotions at the point of sale

(75) Inventor: Robert A. Applegarth, St. Petersburg, FL (US)

Correspondence Address: LARSON AND LARSON, 11199 69TH STREET NORTH, LARGO, FL, 33773, US

(73) Assignee: LIQUID MIST, INC.

(21) Appl. No.: 11/429,631

(22) Filed: May 5, 2006

(51) Int. Cl. G06Q 30/00

(52) U.S. Cl. 705/1; 715/763; 715/964; 715/966; 717/113

(57) ABSTRACT

This invention provides for the mixing of tanning lotion ingredients at the point of purchase. The consumer selects from various optional ingredients and the tanning lotion is created to the consumer's specification at the point of purchase. The tanning lotion is then applied at the point of purchase or at the consumer's desired location. An apparatus for mixing the tanning lotion ingredients includes reservoirs for holding the ingredients situated on a rotatable carousel for access to all reservoirs. Each reservoir has a valve for dispensing a selected amount of ingredient into the custom tanning lotion.

### BACKGROUND OF THE INVENTION

1. Field of the Invention

This invention relates to the field of tanning and more particularly to a method and apparatus for mixing tanning lotions at the point of purchase.

2. Description of the Related Art

Dispensing systems have been used in the paint industry incorporating multiple reservoirs for storing and dispensing of viscous fluids such as paint colorant as disclosed in U.S. Pat. No. 6,273,298 to Post. These systems include reservoirs for storing and dispensing paint colorant mounted on a turntable. The turntable allows the various reservoirs to be rotated until the desired reservoirs is disposed over the container to be filled, at which time a metered amount of colorant is dispensed into a can of base paint.

U.S. Pat. No. 6,540,486 to Amsler, et al., and U.S. Pat. No. 6,398,513 to Amsler, et al., disclose improvements to pump technology which provide for more accurate dispensing of paint colorants and other fluids such as cosmetics. Both of these patents are incorporated herein by reference.

U.S. Pat. No. 6,935,386 to Miller, et al. discloses an automated cosmetics dispenser for point of sale cosmetics products such as shampoos, conditioners and permanent wave solutions and is hereby incorporated by reference. This patent deals specifically with cosmetics and the difficulties dispensing very viscous materials. This patent does not anticipate a very special need in the industry of tanning. In the past, tanning required exposure to ultraviolet light.

It has been shown that a correlation exists between skin cancer and exposure to intense ultraviolet light. To reduce the risk of skin cancer while allowing people to obtain the desired look of a tan, tanning lotions are being used that are applied to the skin and provide a smooth, even tan. Notwithstanding, tanning salons are now providing both ultraviolet tanning and spray-on (lotion) tanning. One problem encountered with either type of tanning is the large number of permutations of ingredients currently available. There are several base lotions providing different levels of tanning or sun protection and different base color ranges. On top of that, skin conditioners are added to soften the skin. Additional dyes and fragrances are also added to improve the look and smell of the resulting tanning lotion. If a tanning salon were to stock all combinations of ingredients, they would need to stock thousands of different lotions—not a cost effective approach.

What is needed is a method and apparatus that will mix a variety of tanning lotion ingredients at the point of purchase, thereby providing greater flexibility to the consumer.

### SUMMARY OF THE INVENTION

It is an objective of the present invention to provide tanning lotions that are mixed and blended at the point of purchase.

It is a further objective of the present invention to provide tanning lotions that are customized for the consumer at the point of purchase.

It is a further objective of the present invention to provide a menu of tanning lotions from which the consumer selects a specific tanning lotion.

It is a further objective of the present invention to permit the consumer to specify a modified formula of a tanning lotion on the menu.

It is a further objective of the present invention to provide the tanning lotion for application at the point of purchase.

It is a further objective of the present invention to provide the tanning lotion for application at the consumer's location of choice.

In one embodiment, a method for providing a custom tanning lotion at a point of sale is disclosed including providing a delivery container (or mixing container) for holding the custom tanning lotion and determining a set of desired ingredients for the custom tanning lotion at the point of sale. Next, for each ingredient in the set of desired ingredients: a container having within the each ingredient is selected and that ingredient is dispensed into the delivery container (or mixing container). When all of the desired ingredients have been dispensed, the custom tanning lotion is mixed within the delivery container (or mixing container) and the custom tanning lotion is provided for use in tanning a person.

In another embodiment, a method of for providing a custom tanning lotion at a point of sale is disclosed including receiving a request for the custom tanning lotion at the point of purchase, providing a delivery container (or mixing container) for holding the custom tanning lotion and determining a set of desired ingredients for the custom tanning lotion at the point of sale. Then, for each ingredient in the set of desired ingredients: selecting that ingredient and dispensing that ingredient into the delivery container. When all desired ingredients are dispensed, the custom tanning lotion is mixed in the delivery container at the point of sale and the custom tanning lotion is provided for tanning of a person at the point of sale.

In another embodiment, an apparatus for combining ingredients to make a tanning lotion at a point of purchase is disclosed including reservoirs, each containing at least one ingredient used in the tanning lotion and each having a valve for dispensing the at least one ingredient into a container. The reservoirs are removably affixed to a carousel for rotatably holding them; providing access to all of the reservoirs.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of an apparatus of a first embodiment of the present invention.

FIG. 2 illustrates a plan view of a second embodiment of the present invention.

FIG. 3 illustrates a flow chart of all embodiments of the present invention.

FIG. 4 illustrates a flow chart of the present invention.

FIG. 5 illustrates a flow chart of the present invention.

FIG. 6 illustrates an exemplary menu for ordering a custom tanning lotion at the point of purchase.

FIG. 7 illustrates a plan view of a third embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The term point of sale includes the locality at which a consumer purchases a product including stores and any adjacent rooms, offices, etc. Furthermore, the term delivery container should be construed in its broadest sense including any intermediate container in which the ingredients are placed for mixing or other purposes with the intent to eventually provide the custom tanning solution to a customer in a container or to apply on a customer.

Tanning lotions are well known in the industry. Some tanning lotions are applied to the skin before tanning in a tanning booth with, for example, ultraviolet light. Some tanning solutions actually color the skin, usually containing Dihydroxyacetone (DHA), which temporarily stains the skin without damage from the sun or artificial ultraviolet light. DHA stains the dead skin cells normally found on the epidermal layer of human skin. The stain or tan lasts for 3-7 days; until the dead skin cells exfoliate. As an example of a tanning solution, a leading manufacture offers a pre-mixed product for home use in 4 ounce, 64 ounce, one gallon and one liter bottles. This tanning solution is comprised of Purified Water, Dihydroxyacetone (DHA), Decyl Polyglucose, Isopropyl Myristate, Xanthan Gum, Propylene Glycol, Propylparaben, Methylparaben, Diazolidinyl Urea, Citric Acid, CI 19140 (Yellow), CI 16035 (Red) and CI 42090 (Blue). Various versions are available with 8%, 10% and 12% DHA. The same pre-mixed product is available in 2.5-gallon jugs for spray booth application. The same manufacturer offers other tanning mixtures that include a tan extender, an exfoliant, moisturizing cream, skin glow and/or a skin rejuvenator. Some tanning mixtures include a sunscreen such as titanium dioxide, zinc oxide or avobenzone to protect from the harmful rays of the sun. Other ingredients include Aloe Vera, Rose Hip Seed Oil, Coenzyme Q-10, Manoi Butter, Noni extract, Jojoba oil, shea butter, macadamia nut oil, L-tyrosine, menthol, Kukui Nut Oil, Methyl Nicotinate, Benzyl Nicotinate, Erythrulose, various fragrances, hemp seed oils and reflective crystals. All of the possible combinations limit the flexibility of the retailer to supply a full line of tanning solutions with various strengths (concentration of DHA), various levels of sun block (SPF), various fragrances and various optional features such as moisturizers, etc, due to the huge number of permutations of ingredients. It is advantageous, therefore, to provide a method and apparatus for selecting and mixing these ingredients into a tanning lotion at the point of purchase (e.g., the point of sale), whereby the consumer is provided the flexibility to select from the range of options based upon their needs and desires.

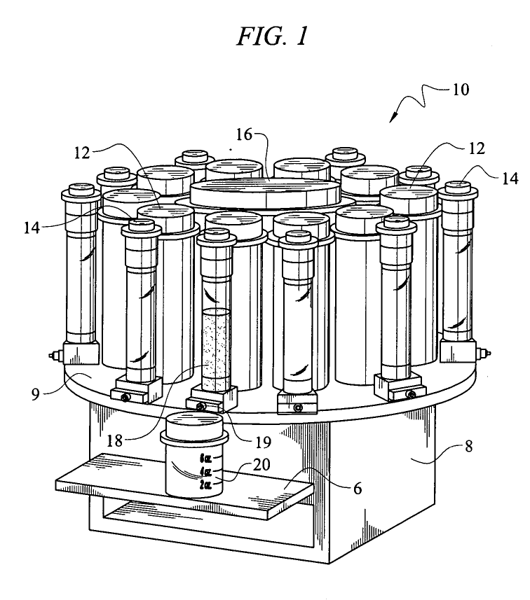

Referring to FIG. 1, a plan view of an apparatus of a first embodiment of the present invention is shown. The tanning lotion dispenser 10 includes a plurality of reservoirs or containers 12/16 for storing and dispensing a variety of ingredients used in tanning. The reservoirs 12/16 are mounted upon a carousel 9 that is rotatably coupled to a base 8 so that the carousel 9 can be rotated to select the desired reservoir 12/16. It is preferred that the reservoirs 12/16 are removably mounted upon the carousel 9 so that they can be removed for cleaning and/or refilling and replaced upon the caroused 9. In the preferred embodiment, one or more larger reservoirs 16 are included to store and dispense the tanning base ingredients, being that a larger quantity of base ingredients are typically used in each mixture. As an example, in one embodiment for sunless tanning, the larger reservoir 16 contains a minimal base solution containing purified water and 8% DHA.

The smaller reservoirs 12 store and dispense ingredients that are used in smaller amounts such as colors and fragrances. Each reservoir 12/16 has a meter 14 for measuring the proper amount of the respective ingredient. Although there are many meter systems known in the prior art and the present invention is not limited to any particular metering system, the system shown includes a clear tube 18 that, in some embodiments, is graduated or marked. The ingredient is pulled into the meter 18 until it reaches the required amount, then the check valve 19 is turned to the dispense position and the metered amount of liquid is dispensed into a container 20. A platform 6 is provided to hold the container 20 and the platform is affixed to the base 8.

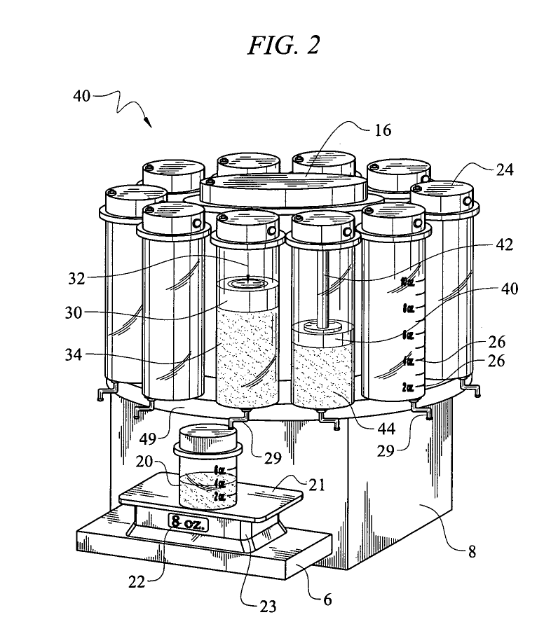

Referring to FIG. 2, a plan view of a second embodiment of the present invention is shown. The tanning lotion dispenser 40 includes a plurality of reservoirs 24/16 for storing and dispensing a variety of ingredients used in tanning. The reservoirs 24/16 are mounted upon a carousel 49 that is rotatably coupled to a base 8 so that the carousel 49 can be rotated to select the desired reservoir 24/16. In the preferred embodiment, one or more larger reservoirs 16 are included to store and dispense the tanning base ingredients, being that a larger quantity of base ingredients are typically used in each mixture. The smaller reservoirs 24 store and dispense ingredients that are used in smaller amounts such as colors and fragrances. In the preferred embodiment, the smaller reservoirs 24 are made of a clear material letting an operator see the amount of liquid it contains. In some embodiments, the reservoirs 24 are graduated or marked 26. Being that many of the liquids 34/44 used in tanning are very viscous, in some embodiments, a piston 30/40 is included within the reservoirs 24 to apply pressure to the liquid 34/44 and reduce clogging. There are many ways to dispense viscous liquids and the methods shown are examples of such. In a first example, a piston 30 is situated above the liquid 34. Air pressure 32 is introduced above the piston 30, thereby biasing the piston 30 downward and urging the liquid 44 towards the bottom of the reservoir 24. In another example, a piston 40 is situated above the liquid 44. The weight of the piston 40 and its shaft 42 bias downward, urging the liquid 34 towards the bottom of the reservoir 24. Delivery valves 29 interfaced to each reservoir are provided to dispense the liquid 34/44 into a container 20. A platform 6 is provided to hold the container 20 and the platform is affixed to the base 8. In one embodiment, a scale 23 is provided for weighing the mixture and the scale has a platform 21 and readout 22 that is either digital or analog.

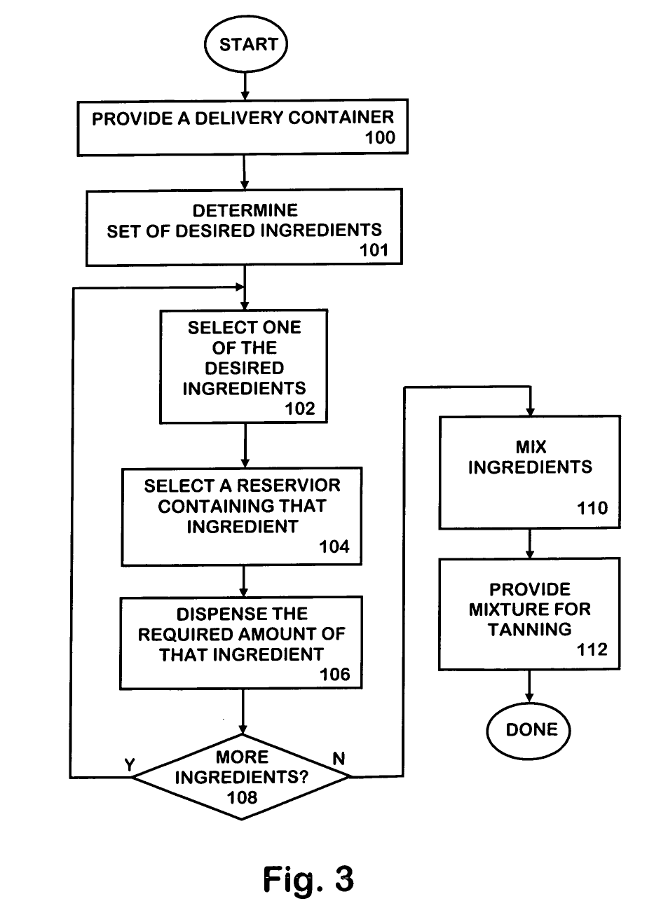

Referring to FIG. 3, a flow chart of all embodiments of the present invention is shown. The first step is to provide a container for storing and delivering 100 the mixture to a customer. In some embodiments, the set of desired ingredients is selected by the customer from a menu of discrete ingredients or from a menu of pre-tested combinations. Next, based upon the customer's needs and desires, a set of desired ingredients 101 is determined. This step includes selecting a base, one or more active tanning ingredients to achieve the desired shade of tan, optionally, one or more fragrances and, optionally, one or more colors. The optional colors are added to improve the aesthetic look of the resulting mixture. Next, for each ingredient in the set of desired ingredients, one of the ingredients is selected 102 and a reservoir 12/16/24 containing that ingredient is selected 104 (by rotating the carousel 9/49) and the desired amount of that ingredient is dispensed 106 into the delivery container. If there are more ingredients remaining that have not been dispensed 108, steps 102-108 are repeated until all of the desired ingredients have been dispensed, at which time the ingredients are mixed 110 and provided to the customer for tanning 112.

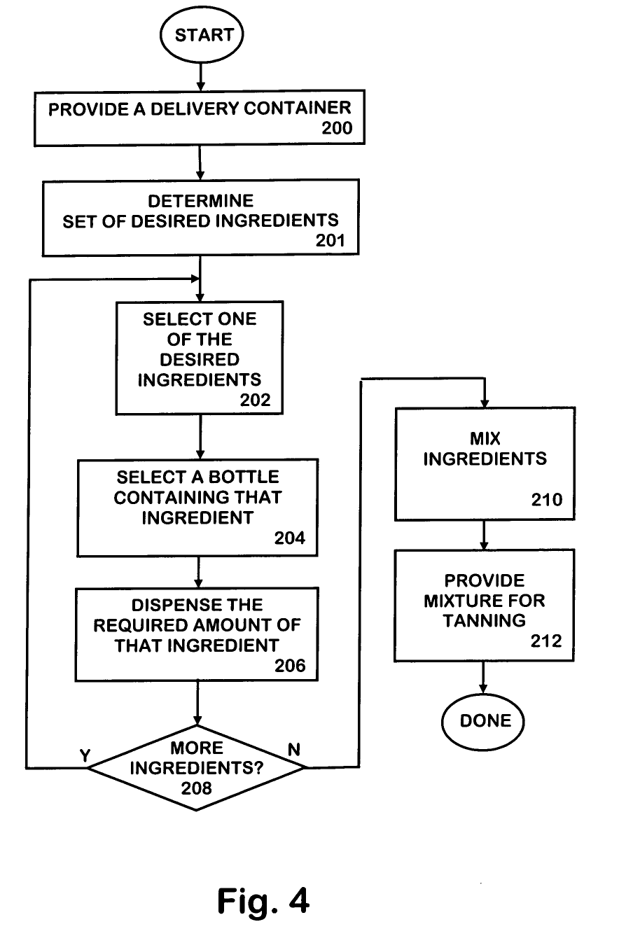

Referring to FIG. 4, a flow chart of the present invention is shown. The first step is to provide a container for storing and delivering 200 the mixture to a customer. Next, based upon the customer's needs and desires, a set of desired ingredients 201 is determined. This step includes selecting a base, one or more active tanning ingredients to achieve the desired shade of tan or UV-protection, optionally, one or more fragrances and, optionally, one or more colors. The optional colors are added to improve the aesthetic look of the resulting mixture. Next, for each ingredient in the set of desired ingredients, one of the ingredients is selected 202 and a storage container holding that ingredient is selected 204 and the desired amount of that ingredient is dispensed 206 into the delivery container 20. The storage container is any container normally used to hold the various ingredients used in making tanning lotions. It is preferred that the storage container has a lid to prevent the liquids from drying out and a spout or pump for accurate dispensing of the proper amounts of the ingredients. In some embodiments, the storage container is of the shape of a plastic squeeze bottle similar to a shampoo bottle or the like. In some embodiments, the container is a bottle with a pump similar to the containers used for hand lotions. Furthermore, in some embodiments, the container is a bottle with a metered pump, providing accurate amounts of the contained liquid.

If there are more ingredients remaining that have not been dispensed 208, steps 202-208 are repeated until all desired ingredients have been dispensed, at which time the ingredients are mixed 210 and provided to the customer for tanning 212.

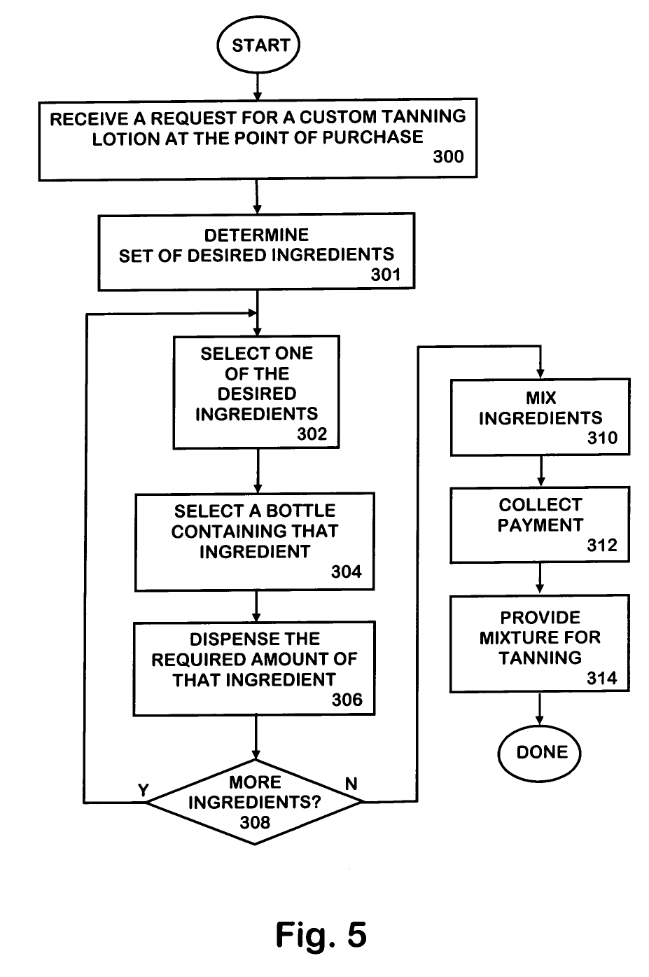

Referring to FIG. 5, a flow chart of the present invention is shown. The first step is to receive a request for a custom tanning lotion from a customer 300. The request may be for a specific tanning lotion that is on a menu of tanning lotions or, in some embodiments, the tanning lotion is of the customer's creation. For example, in one embodiment, the customer requests a tanning lotion from a menu that has 10% DHA, vanilla fragrance and other ingredients not listed for brevity. In another example, the customer requests a tanning lotion as in the previous embodiment, but requests 12% DHA and coconut fragrance. Next, based upon the customer's needs and desires, a set of desired ingredients 301 is determined. This step includes selecting a base, one or more active tanning ingredients to achieve the desired shade of tan, optionally, one or more fragrances and, optionally, one or more colors. The optional colors are added to improve the aesthetic look of the resulting mixture. Next, for each ingredient in the set of desired ingredients, one of the ingredients is selected 302 and a storage container holding that ingredient is selected 304 and the desired amount of that ingredient is dispensed 306 into the delivery container 20. The storage container is any container normally used to hold the various ingredients used in making tanning lotions. It is preferred that the storage container has a lid to prevent the liquids from drying out and a spout for accurate dispensing of the proper amounts of the ingredients. In some embodiments, the storage container is of the shape of a plastic squeeze bottle similar to a shampoo bottle or the like. In some embodiments, the container is a bottle with a pump similar to the containers used for hand lotions. Furthermore, in some embodiments, the container is a bottle with a metered pump, providing accurate amounts of the contained liquid.

If there are more ingredients remaining that have not been dispensed 308, steps 302-308 are repeated until all desired ingredients have been dispensed, at which time the ingredients are mixed 310, a payment is collected from the customer 312 and the finished mixture is provided to the customer for tanning 314.

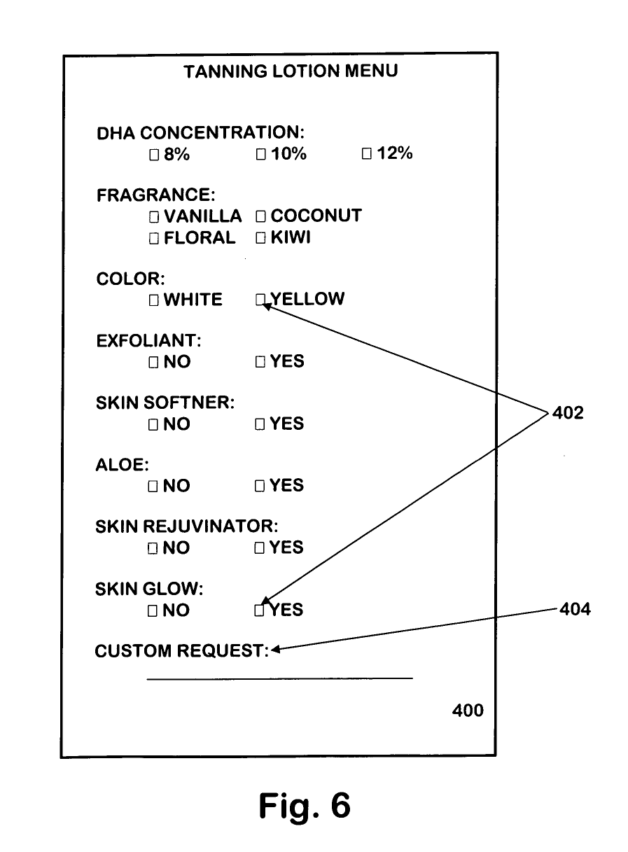

Referring to FIG. 6, an exemplary menu for ordering a custom tanning lotion at the point of purchase is shown. The menu 400 provides selection criteria that the customer selects at the point of purchase, thereby requesting a tanning lotion that meets their needs and desires. In this example menu, the customer selects the desired ingredients by checking boxes 402. Note that some ingredients are common among all tanning lotions and are not selectable by the customer. For example, all sunless tanning lotions have a common base of purified water and a minimum amount of DHA. In this example menu 400, there is a line 404 for the customer to indicate a change to the standard requests. For example, the customer may write on the custom request line 404 that they want extra vanilla fragrance or 16% DHA. The example menu 400 is purely an example and many other menus are possible. In some embodiments, the menu has pre-tested combinations of ingredients, whereby the customer selects a particular combination by name, for example, “Hawaiian Bronze,” which translates to a combination of ingredients with coconut fragrance and yellow color. In that example, the customer is still free to specify their desired strength of tanning agent (DHA).

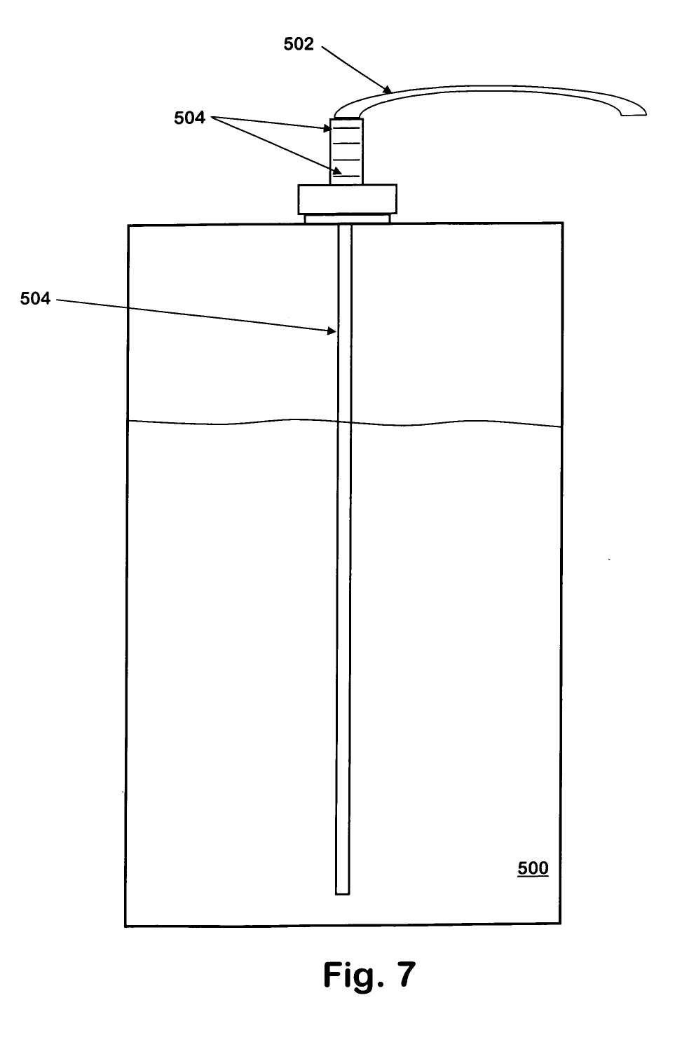

Referring to FIG. 7, a plan view of an apparatus of a third embodiment of the present invention is shown. Shown is an alternate container 500 for dispensing the tanning ingredients at the point of purchase. The container 500 can be of any size and can be supplied with one or more tanning lotion ingredients. The container 500 includes a pump 502 that dispenses an amount of the contents of the container 500. In some embodiments, a single press of the pump 502 dispenses a fixed amount of the contents. In another embodiment, the pump 502 is metered with meter marks 504, thereby allowing accurate dispensing of specific amounts of the contents. A siphon tube 504 extends into the container 500 for extracting contents from the bottom of the container 500.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for providing a custom tanning lotion at a point of sale, the method comprising:
providing a delivery container for holding the custom tanning lotion;
determining a set of desired ingredients for the custom tanning lotion at the point of sale;
for each ingredient in the set of desired ingredients:
selecting a container having within the each ingredient; and
dispensing the each ingredient into the delivery container;
mixing the custom tanning lotion within the delivery container; and
providing the custom tanning lotion for use in tanning a person.

2. The method for providing a custom tanning lotion at the point of sale of claim 1, wherein the containers are pump bottles.

3. The method for providing a custom tanning lotion at the point of sale of claim 1, wherein the containers are a plurality of reservoir and the plurality of reservoirs is affixed to a rotatable carousel.

4. The method for providing a custom tanning lotion at the point of sale of claim 1, wherein the set of desired ingredients includes Dihydroxyacetone.

5. The method for providing a custom tanning lotion at the point of sale of claim 1, wherein the set of desired ingredients includes at least one fragrance.

6. The method for providing a custom tanning lotion at the point of sale of claim 1, further comprising the step of collecting a payment before the step of providing the custom tanning solution for tanning of a person.

7. The method for providing a custom tanning lotion at the point of sale of claim 1, wherein the tanning of a person is performed at the point of sale.

8. A method for providing a custom tanning lotion at a point of sale, the method comprising:
receiving a request for the custom tanning lotion at the point of purchase;
providing a delivery container for holding the custom tanning lotion;
determining a set of desired ingredients for the custom tanning lotion at the point of sale;
for each ingredient in the set of desired ingredients:
selecting the each ingredient; and
dispensing the each ingredient into the delivery container;
mixing the custom tanning lotion in the delivery container at the point of sale; and
providing the custom tanning lotion for tanning of a person at the point of sale.

9. The method for providing a custom tanning lotion at the point of sale of claim 8, wherein the each ingredient is stored in individual bottles and the dispensing step includes dispensing the each ingredient from the individual bottles into the delivery container.

10. The method for providing a custom tanning lotion at the point of sale of claim 8, wherein the each ingredient is stored in one of a plurality of reservoirs and the plurality of reservoirs is removably affixed to a rotatable carousel and the dispensing step includes dispensing the each ingredient from the one of the reservoirs into the delivery container.

11. The method for providing a custom tanning lotion at the point of sale of claim 8, wherein the set of desired ingredients includes Dihydroxyacetone.

12. The method for providing a custom tanning lotion at the point of sale of claim 8, wherein the set of desired ingredients includes at least one fragrance.

13. The method for providing a custom tanning lotion at the point of sale of claim 8, further comprising the step of collecting a payment before the step of providing the custom tanning lotion for tanning of a person.

14. An apparatus for combining ingredients to make a tanning lotion at a point of purchase, the apparatus comprising:
a plurality of reservoirs, each of the plurality of reservoirs containing at least one ingredient used in the tanning lotion;
a valve adapted to each reservoir of the plurality of reservoirs for dispensing the at least one ingredient;
a carousel for rotatably holding the plurality of reservoirs, each of the plurality of reservoirs removably affixed to the carousel, the carousel providing access to all of the plurality of reservoirs; and
a container for receiving at least two of the at least one ingredients.

15. The apparatus of claim 14, wherein the at least one ingredient includes Dihydroxyacetone.

16. The apparatus of claim 14, wherein the tanning lotion is applied to a person's skin before tanning by ultraviolet light.

17. The apparatus of claim 14, further comprising a scale for weighing the container for receiving.

18. The apparatus of claim 14, further comprising a piston inside each of the reservoirs, the piston urging the at least one ingredient in the each reservoir towards the at least one valve adapted to the each reservoir.

19. The apparatus of claim 18, wherein the piston is biased by a weight.

20. The apparatus of claim 18, wherein the piston is biased by air pressure.
